(19) United States
(12) Patent Application Publication
(10) Pub. No.: US 2017/0342787 A1
(43) Pub. Date: Nov. 30, 2017

(54) INTEGRATED MUD GAS SEPARATOR SKID

(71) Applicant: Nabors Drilling Technologies USA, Inc., Houston, TX (US)

(72) Inventors: Ashish GUPTA, Houston, TX (US); Derek PATTERSON, Houston, TX (US)

(21) Appl. No.: 15/610,222

(22) Filed: May 31, 2017

Related U.S. Application Data
(60) Provisional application No. 62/343,724, filed on May 31, 2016.

(51) Int. Cl. E21B 21/06; B01D 19/00

(52) U.S. Cl. CPC E21B 21/067; B01D 19/0031

(57) ABSTRACT

An integrated mud gas separator skid includes a frame and a mud gas separator. The integrated mud gas separator skid may include one or more fluid conduits for use with a drilling rig, including an integrated vent line, a high pressure line, a low pressure line, a standpipe manifold, a rig water supply line, a diesel line, an air line, and a rig water return line. The integrated mud gas separator skid may be mechanically coupled to a drilling rig. The integrated mud gas separator skid may need only one crane lift to be mechanically coupled to the drilling rig.

### CROSS-REFERENCE TO RELATED APPLICATIONS

This application is a nonprovisional application that claims priority from U.S. provisional application No. 62/343,724, filed May 31, 2016.

### TECHNICAL FIELD/FIELD OF THE DISCLOSURE

The present disclosure relates to equipment for a drilling rig, and specifically to mud processing equipment for a drilling rig.

### BACKGROUND OF THE DISCLOSURE

When drilling a wellbore, fluids may be circulated through the wellbore. Drilling fluids, referred to herein as drilling mud, may be circulated through the wellbore during a drilling operation to, for example and without limitation, lubricate downhole tools, clear cuttings, etc. While drilling the wellbore, drilling mud may be pumped from the surface through a drill string in the wellbore. The drilling mud may return to the surface in the annular space between the drill string and the wellbore. During some drilling operations, gas from the surrounding formation may enter the wellbore and may be introduced into the drilling mud stream. In some cases, the gas may pose a safety hazard to rig operations as it may be, for example and without limitation, flammable.

### SUMMARY

The present disclosure provides for an integrated mud gas separator skid. The integrated mud gas separator skid may include a frame and a mud gas separator positioned within and mechanically coupled to the frame.

The present disclosure also provides for a method. The method may include providing a drilling rig. The method may also include transporting an integrated mud gas separator skid to the drilling rig. The integrated mud gas separator skid may include a frame and a mud gas separator positioned within and mechanically coupled to the frame. The method may also include mechanically coupling the integrated mud gas separator skid to the drilling rig.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a perspective view of an integrated mud gas separator skid consistent with at least one embodiment of the present disclosure.

FIG. 2 depicts an elevation view of an integrated mud gas separator skid consistent with at least one embodiment of the present disclosure.

FIG. 3 depicts a cross section view of a mud gas separator of the integrated mud gas separator skid of FIG. 2.

FIG. 4 depicts a perspective view of a drilling rig including an integrated mud gas separator skid consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

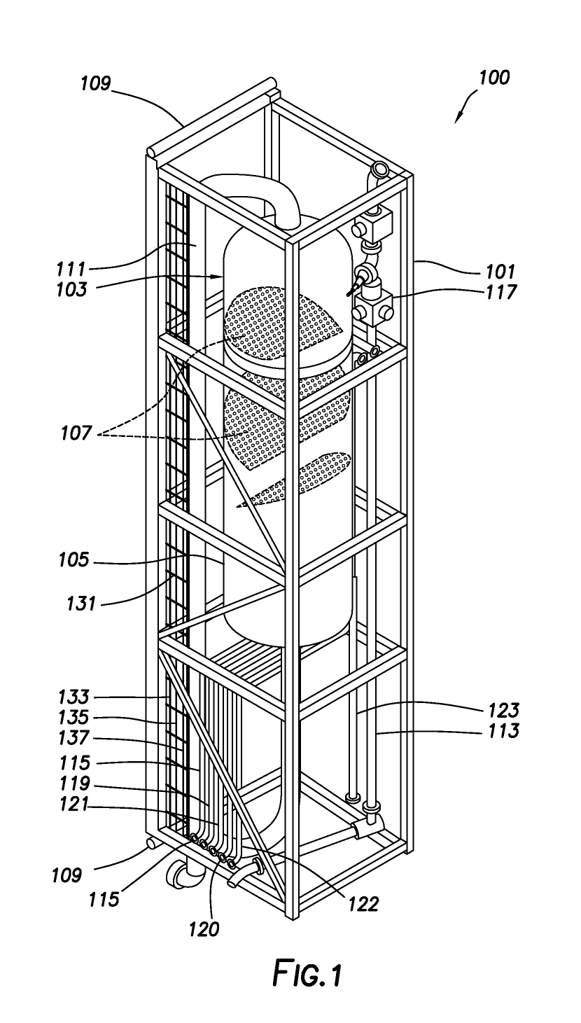

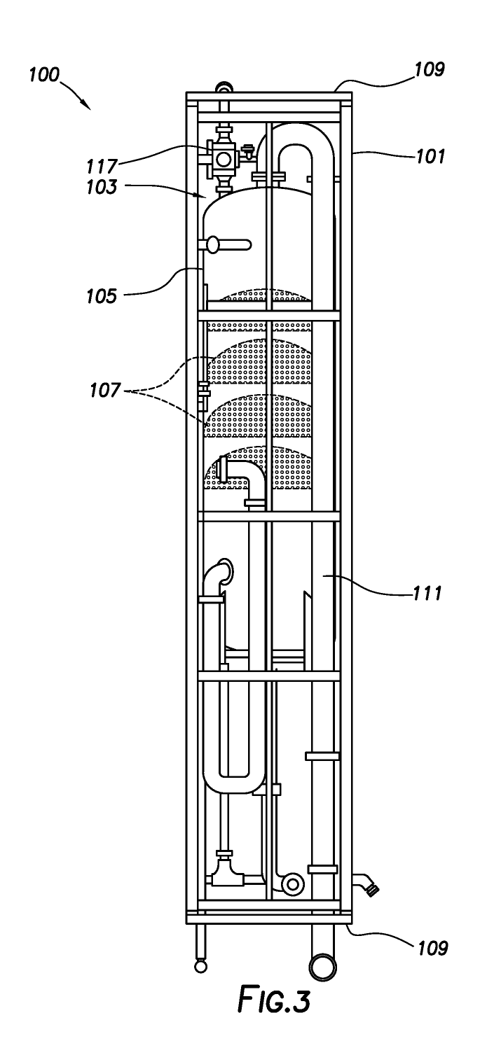

FIGS. 1-3 depict integrated mud gas separator skid 100 consistent with at least one embodiment of the present disclosure. In some embodiments, integrated mud gas separator skid 100 may include frame 101 and mud gas separator 103. Mud gas separator 103 may be any mud gas separator as understood in the art. In some embodiments, as depicted in FIGS. 1-3, mud gas separator 103 may be a vertical mud gas separator. Mud gas separator 103 may include outer vessel 105 and one or more separator plates 107 positioned therein. Separator plates 107 may, for example and without limitation, allow the gaseous portion of fluid introduced into mud gas separator 103 to be separated from the liquid portion of the fluid. One having ordinary skill in the art with the benefit of this disclosure will understand that the specific arrangement of mud gas separator 103 is merely exemplary and is not intended to limit the scope of this disclosure.

In some embodiments, mud gas separator 103 may be positioned within and mechanically coupled to frame 101. Frame 101 may be formed in the shape of a generally rectangular prism. In some embodiments, frame 101 may be a resilient frame. In some embodiments, frame 101 may be utilized to transport integrated mud gas separator skid 100 by, for example and without limitation, a winch truck. Frame 101 may be sized such that it is transportable by a single winch truck.

In some embodiments, frame 101 may be sized such that it complies with transportation regulations. For example and without limitation, in some embodiments, frame 101 may be formed such that it is at most 8′6″ wide and 9′6″ in depth, such that when transported in a horizontal position, integrated mud gas separator skid 100 is a non-permit load. In some embodiments, frame 101 may include tail rolls 109. Tail rolls 109 may be one or more bars or other mounting points for allowing integrated mud gas separator skid 100 to be loaded onto a winch truck.

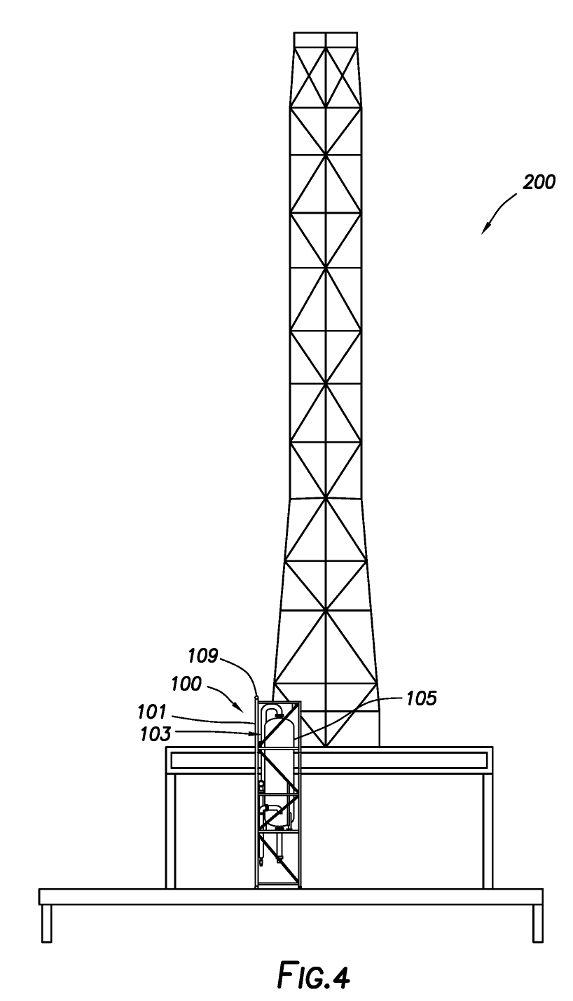

In some embodiments, integrated mud gas separator skid 100 may be adapted to mechanically couple to a drilling rig 200 as depicted in FIG. 4. Integrated mud gas separator skid 100 may be transported in a horizontal position and may, when installed to drilling rig 200, be lifted to a vertical position. One or more fluid connections may be made between drilling rig 200 and components of integrated mud gas separator skid 100. For example, mud gas separator 103 may be coupled to a mud rig water return line from drilling rig 200 and may be operated to separate the gaseous portion of fluid introduced into mud gas separator 103 from the liquid portion of the fluid.

In some embodiments, integrated mud gas separator skid 100 may include one or more fluid conduits for use with drilling rig 200. These fluid conduits may transfer one or more fluids required for the operation of drilling rig 200 including, for example and without limitation, air, water, mud, diesel fuel, or any other fluid.

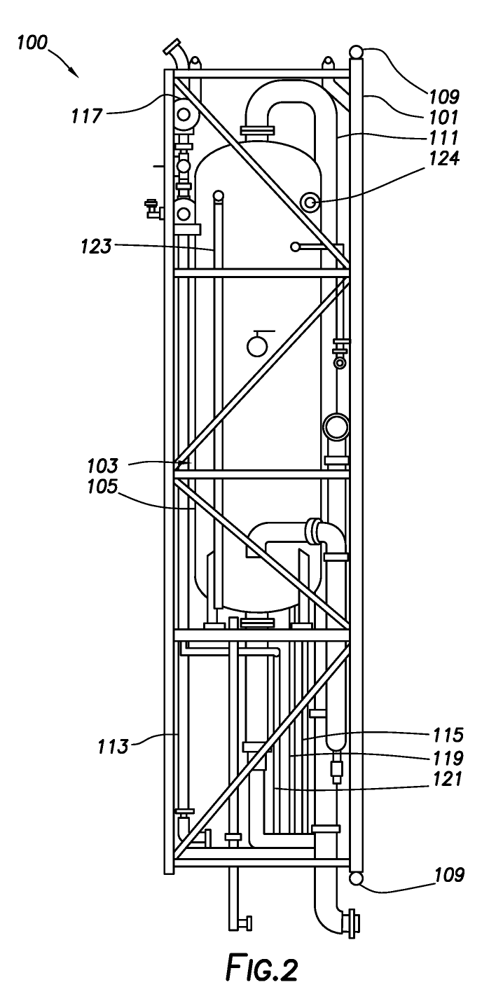

For example, as depicted in FIGS. 1 and 2, integrated mud gas separator skid may include integrated vent line 111, high pressure line 113, low pressure line 115, standpipe manifold 117, rig water supply line 119, diesel line 120, rig water return line 121, and air line 122. In some embodiments, choke line 123 and choke inlet 124 may be included in integrated mud gas separator skid 100. In some embodiments, integrated mud gas separator skid 100 may be arranged such that, when integrated mud gas separator skid 100 is mechanically coupled to drilling rig 200, one or more of high pressure line 113, low pressure line 115, standpipe manifold 117, rig water supply line 119, diesel line 120, rig water return line 121, and air line 122 are aligned with respective connections on drilling rig 200. One having ordinary skill in the art with the benefit of this disclosure will understand that although certain lines are called out herein, this list is not intended to be limiting to the present disclosure. Other lines, such as, for example and without limitation, panic lines, air lines, steam lines, and drilling mud lines may be included. Additionally, supply and rig water return lines for any of these systems including air, water, steam, and drilling mud may be included.

In some embodiments, integrated mud gas separator skid 100 may include one or more electrical wires or cables for use with drilling rig 200. These wires or cables may provide electrical connections for use with the operation of drilling rig 200. For example, integrated mud gas separator skid 100 may include one or more power lines 133, control wires 135, or utility cables 137. In some embodiments, integrated mud gas separator skid 100 may include cable tray 131. Cable tray 131 may, for example and without limitation, provide a path for electrical wires or cables such as power lines 133, control wires 135, or utility cables 137, to traverse integrated mud gas separator skid 100.

In some embodiments, the number of loads required to transport or move drilling rig 200 including mud gas separator 103 may be minimized by including one or more of integrated vent line 111, high pressure line 113, low pressure line 115, standpipe manifold 117, rig water supply line 119, diesel line 120, rig water return line 121, and air line 122 with mud gas separator 103 in integrated mud gas separator skid 100. In some embodiments, by integrating one or more of integrated vent line 111, high pressure line 113, low pressure line 115, standpipe manifold 117, rig water supply line 119, diesel line 120, rig water return line 121, and air line 122 into integrated mud gas separator skid 100, the number of crane lifts required to rig up drilling rig 200 may be reduced from those required to rig up a mud gas separator, stand pipe, and any other component not included in integrated mud gas separator skid 100. In some embodiments, only a single crane lift may be needed to mechanically couple integrated mud gas separator skid 100 to drilling rig 200.

In some embodiments, by integrating integrated vent line 111, high pressure line 113, low pressure line 115, standpipe manifold 117, rig water supply line 119, diesel line 120, rig water return line 121, and air line 122 into integrated mud gas separator skid 100, rigging up and rigging down of drilling rig 200 may be simplified by reducing the number of connections to be made.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An integrated mud gas separator skid comprising:
a frame; and
a mud gas separator, the mud gas separator positioned within and mechanically coupled to the frame.

2. The integrated mud gas separator skid of claim 1, further comprising one or more of an integrated vent line, high pressure line, low pressure line, standpipe manifold, rig water supply line, diesel line, air line, and rig water return line positioned within and mechanically coupled to the frame.

3. The integrated mud gas separator skid of claim 1, wherein the frame is formed in the shape of a generally rectangular prism.

4. The integrated mud gas separator skid of claim 1, wherein the frame further comprises one or more tail rolls.

5. The integrated mud gas separator skid of claim 1, wherein the frame is at most 8′6″ wide and 9′6″ in depth.

6. The integrated mud gas separator skid of claim 1, wherein the mud gas separator is a vertical mud gas separator.

7. The integrated mud gas separator skid of claim 6, wherein the mud gas separator further comprises an outer vessel and one or more separator plates positioned therein.

8. The integrated mud gas separator skid of claim 1, further comprising one or more of a power line, control wire, or utility cable.

9. The integrated mud gas separator skid of claim 8, further comprising a cable tray, the one or more of a power line, control wire, or utility cable positioned within the cable tray.

10. A method comprising:
providing a drilling rig;
transporting an integrated mud gas separator skid to the drilling rig, the integrated mud gas separator skid including:
a frame; and
a mud gas separator, the mud gas separator positioned within and mechanically coupled to the frame; and
mechanically coupling the integrated mud gas separator skid to the drilling rig.

11. The method of claim 10, further comprising separating a gaseous portion of a fluid introduced into the mud gas separator from a liquid portion of the fluid.

12. The method of claim 10, wherein the integrated mud gas separator skid further comprises one or more of an integrated vent line, high pressure line, low pressure line, standpipe manifold, rig water supply line, diesel line, rig water return line, and air line positioned within and mechanically coupled to the frame.

13. The method of claim 10, wherein the frame is formed in the shape of a generally rectangular prism.

14. The method of claim 10, wherein the frame further comprises one or more tail rolls.

15. The method of claim 10, wherein the frame is at most 8′6″ wide and 9′6″ in depth.

16. The method of claim 10, wherein the mud gas separator is a vertical mud gas separator.

17. The method of claim 16, wherein the mud gas separator further comprises an outer vessel and one or more separator plates positioned therein.

18. The method of claim 10, wherein mechanically coupling the integrated mud gas separator skid to the drilling rig comprises a single crane lift.

19. The method of claim 10, wherein the integrated mud gas separator further comprises one or more of a power line, control wire, or utility cable.

20. The method of claim 11, wherein the integrated mud gas separator further comprises a cable tray, wherein the one or more of a power line, control wire, or utility cable are positioned within the cable tray.
